(19) United States
(12) Patent Application Publication
(10) Pub. No.: US 2016/0287013 A1
(43) Pub. Date: Oct. 6, 2016

(54) INSLUATED FIRE RETARDANT SLEEVE FOR CHAFING DISH

(71) Applicant: Lisa Lee Rhodes, Akron, OH (US)

(72) Inventor: Lisa Lee Rhodes, Akron, OH (US)

(21) Appl. No.: 15/086,878

(22) Filed: Mar. 31, 2016

Related U.S. Application Data
(60) Provisional application No. 62/141,418, filed on Apr. 1, 2015.

(51) Int. Cl. A47J 36/26

(52) U.S. Cl. CPC A47J 36/26

(57) ABSTRACT

An insulated fire retardant sleeve that prevents the escape of steam from between nested food service trays that assists in keeping food hot. Using the device allows for less time refilling the buffet with food and requires fewer servers to get the job done.

### CROSS-REFERENCE TO RELATED APPLICATION

This application claims the benefit of priority of U.S. provisional application No. 62/141,418, filed Apr. 1, 2015, the contents of which are herein incorporated by reference.

### BACKGROUND OF THE INVENTION

The present invention relates to food service systems, and more particularly to chafing dishes for serving heated food items.

Serving dishes for dining at buffets, dinner events, and other catered events have traditionally used chafing dishes and other serving systems, which employ a heated reservoir of water to keep the food contained in a serving tray to keep warm. While more formal chafing dishes and their support stands provide a close fitment between the lip of the serving dish and the heating reservoir, the same is not true of disposable serving trays, that have become popular for more informal catered events. The disposable trays reduce the cleanup costs and avoid a substantial investment in more formal wares.

Currently ½ pans are the only disposable serving trays presently available to keep food hot when using the wire supported chafing dishes. Accordingly, the number of people being served on a buffet line is limited to 12-15 people per pan of food. This requires frequent changing of the trays and additional servers to complete the tasks along with serving the food items.

In addition, the frequent changing of the trays results in an accelerated loss of warming fluids, such as water, when the trays are changed out. The loss of water limits the heating capacity of the warmers, which can present health hazards when the food items are not maintained at the proper temperatures.

As can be seen, there is a need for a system, method, and food service item that keep food warmer, reduce evaporation of the warming water, and permit use of larger sized serving dishes, particularly for disposable food service trays.

### SUMMARY OF THE INVENTION

In one aspect of the present invention, food service system, includes: a frame having one or more burner receptacles; a lower pan supported by the frame and positioned above the burner receptacles; a spacer rack adapted to be received within the lower pan and supported by a bottom surface of the lower pan; an upper pan adapted to be received within the lower pan and maintained in a nested spaced apart relation from the lower pan by the spacer rack, wherein a gap is formed between a peripheral edge surface of the upper pan and the lower pan when the upper pan is nested within the lower pan; and a band adapted to enclose the gap. The band may include: a layer of insulating material; an elastic material; and an outer layer of material substantially enclosing the layer of insulating material and the elastic material. In some embodiments, the layer of insulating material further comprises a blend of a polyester and a metalized polyester. In other embodiments of the invention, the outer layer of material is a fire retardant material. A pocket may be formed as a fold along a lateral edge of the outer material and the elastic material may be received within the pocket.

In other aspects of the invention, a food service method, includes: providing an upper pan adapted to be received within a lower pan and maintained in a nested spaced apart relation from the lower pan by a spacer rack, wherein a gap is formed between a peripheral edge surface of the upper pan and the lower pan when the upper pan is nested within the lower pan; and securing a band around the upper tray and the lower tray to enclose the gap, the band having a layer of insulating material and an elastic material substantially enclosed by an outer layer of material. The food service method may also include: supporting the upper pan and the lower pan on a rack, wherein the rack is adapted to receive a heating element in a receptacle disposed beneath the lower pan. The food service method may also include partially filling the lower pan with a warming fluid; and applying heat from the heating element to the lower pan. The food service method also includes containing a food item within the upper tray. The layer of insulating material is a blend of polyester and metalized polyester; and the outer layer is formed from a fire retardant material.

Yet other aspects of the invention include a food service item. The food service item is a closure band having a layer of insulating material; an elastic material; and an outer layer of material substantially enclosing the layer of insulating material and the elastic material. The layer of insulating material may be a blend of a polyester and a metalized polyester. The outer layer of material may be a fire retardant material. A pocket may formed as a fold along a lateral edge of the outer material and the elastic material may be received within the pocket. The closure band is adapted to enclose a gap formed between a peripheral edge surface of an upper serving pan and a lower serving pan when the upper pan is received in a nested configuration within the lower pan.

These and other features, aspects and advantages of the present invention will become better understood with reference to the following drawings, description and claims.

### BRIEF DESCRIPTION OF THE DRAWINGS

FIG. 1 is a perspective view of a food service system according to aspects of the invention.

FIG. 2 is a perspective view of a closure band according to other aspects of the invention.

FIG. 3 is a section view of a food service system taken from line 3-3 in FIG. 1.

FIG. 4 is an enlarged section view of the closure band around a gap formed between the nested pans.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an apparatus and method for a food service system which includes a band adapted to retain heat and moisture for a food service chafing dish configuration.

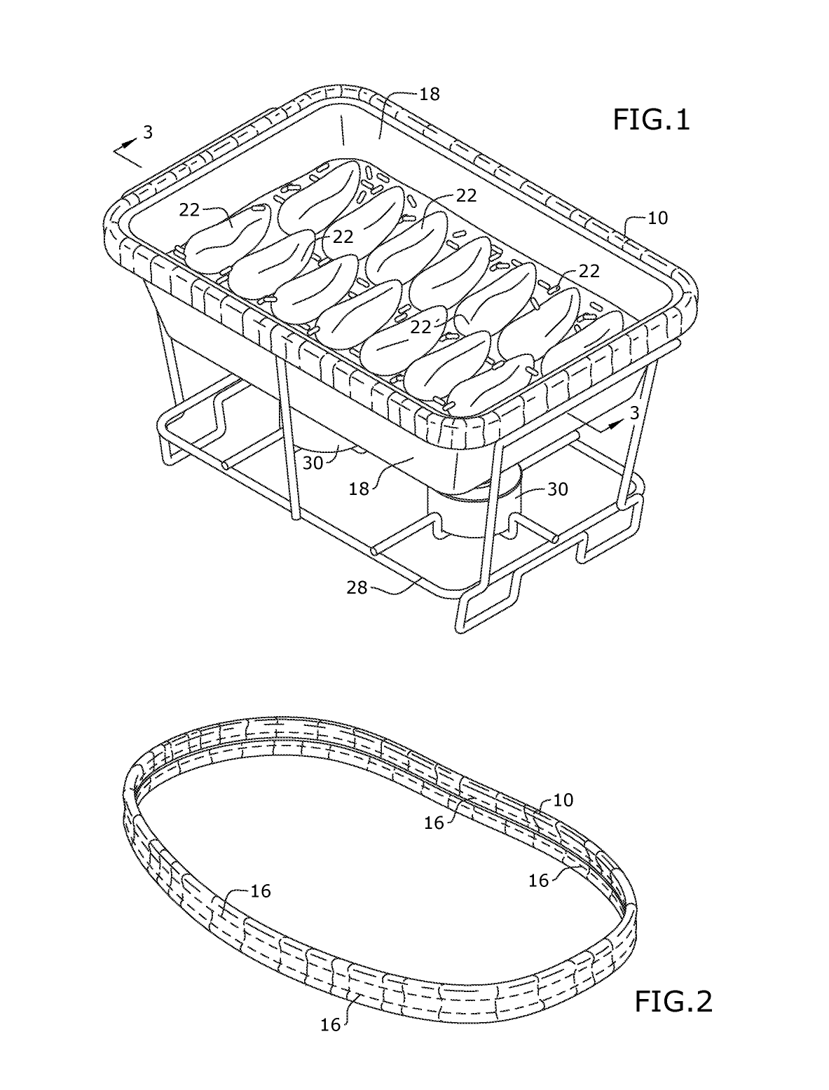

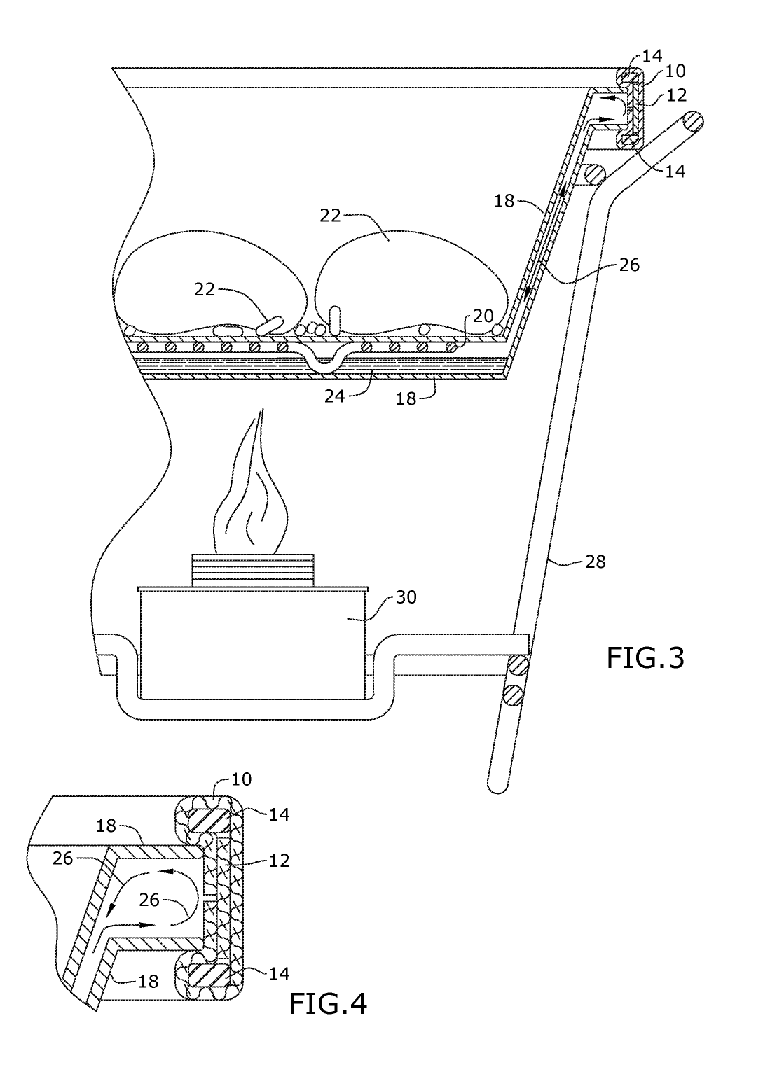

A food service system according to aspects of the invention is depicted in reference to FIGS. 1, 3, and 4. The food service system includes a pair of nested serving pans or trays 18, including an upper pan 18 and a lower pan 18. As best seen in reference to FIG. 3, a spacing rack 20 is interposed between the upper pan 18 and the lower pan 18, to maintain the upper pan 18 in an elevated position with respect to the lower pan 18 and provide a containment reservoir for containing a warming fluid 24.

The lower pan 18 may be partially filled with a quantity of warming fluid 24, which is typically water. One or more food items 22 are contained within the upper pan 18.

The nested pans 18 are supported by a frame, or stand 28. In the embodiment depicted, the stand 28 may be formed with a wire frame, with a peripheral edge of the upper portion of the frame 28 supporting a lip of the pans 18. The frame 28 may also be configured to support a lower portion of the pans 18 contained therein.

The stand 28 may also have one or more receptacles for containing a heating element 30, such as a burner 30. The burner 30 may include a disposable type burner 30, such as a can of Sterno, an alcohol burner, or the like. The burner 30 is retained in the receptacles to selectively apply heat to a bottom surface of the lower pan 18.

The heat applied by the burner 30 heats the warming fluid 24 contained within the lower pan 18 to provide a stabilized temperature for the food items 22 contained within the upper pan 18. When water is utilized as the warming fluid 24, the water 24 is heated by the burner 30 and its temperature will stabilize approximately around its boiling point and is intended tol maintain the food at a suitable temperature according to generally applicable food service standards.

As seen in reference to FIGS. 3 and 4, a gap is formed between an outer lip of the upper and lower pans 18. Without the band 10 according to aspects of the present invention, the steam 26 produced by the heating element 30 influence on the warming fluid 24 will escape through the gap, presenting a potential burn hazard to the food service personnel and other persons filling or retrieving food items 22 to and from the tray. In addition, over time, the escaping steam 26 will also deplete the warming fluid source 24 such that the warming fluid 24 will not provide an adequate heat source for the food items 22 contained within the upper pan 18.

A band 10 according to aspects of the invention is applied around the periphery of the nested pans 18 so as to contain the steam 26 within the containment reservoir. The band 10 may be formed from a length of elastic material 14, a layer of insulating material 12, and an outer layer of material 10. The insulating material 12 may be a polyester and metalized polyester blended fabric, more preferably a blend of 93.75% polyester and 6.25% metalized polyester, such as Insul-Brite®, manufactured by The Warm Company of Lynwood, Wash. The insulating material 12 may be substantially enclosed by the outer layer 10 and joined with the elastic material 14 via stitching 16. Preferably, the outer layer 10 is formed of a fire retardant material.

A band of the present invention may be formed by cutting the fire retardant material 10 in strips about 6″ wide by 76″ long. The insulating material 12 may be formed by cutting strips about 4″ wide by 76″ long. The insulating material 12 strip may be placed proximal to the middle of the outer material 10 with the insulating side of the material 12 facing up on the outer material 10. The insulating material 12 may then be sewn to the outer material 10. The ends of the outer material 10 may then be folded over the insulating material 12 so as form pockets along an outer edge of each side of the outer material 10 so the elastic 14 can be threaded through the pocket. The opposed ends of the joined strips may then be sewn together making the sleeve a complete loop. The sleeve is preferably formed such that the elastic bands enclose a top surface defined along a peripheral lip of the upper pan 18 and a bottom surface defined along a peripheral lip of the lower pan 18.

The fire retardant material 10 gives the user protection from starting a fire if the sleeve 10 is inadvertently dropped onto the burner 30 beneath the stand 28. The insulating material 12 allows for the escaping heat and steam 26 from under the food pan 18 to be pushed back within the containment reservoir. This allows the water 24 beneath the food pan 18 to stay very hot and maintain the food items 22 being served well above the specified 140 degree temperature for serving required by health department food service standards. The elastic component 14 of the sleeve 10 gathers both sides of the sleeve together so it fits around the nested pans 18 to retain the heat in and below the food pan 18. The band 10 fitment around the pans 18 permits a small amount of the steam 26 the ability to escape and avoid pressurization of the containment reservoir. This prevents a flash of steam 26 developing when switching out an empty food service pan 18 for a full food pan 18 when the food items 22 have been depleted.

Aspects of the present invention are well suited for maintaining the temperatures of food items served in chafing dish configuration, and are preferably employed with disposable food service trays, frequently utilized in certain catering operations.

It should be understood, of course, that the foregoing relates to exemplary embodiments of the invention and that modifications may be made without departing from the spirit and scope of the invention as set forth in the following claims.

What is claimed is:

1. A food service system, comprising:
a frame having one or more burner receptacles;
a lower pan supported by the frame and positioned above the burner receptacles;
a spacer rack adapted to be received within the lower pan and supported by a bottom surface of the lower pan;
an upper pan adapted to be received within the lower pan and maintained in a nested spaced apart relation from the lower pan by the spacer rack, wherein a gap is formed between a peripheral edge surface of the upper pan and the lower pan when the upper pan is nested within the lower pan; and
a band adapted to enclose the gap.

2. The food service system of claim 1, wherein the band comprises:
a layer of insulating material;
an elastic material; and
an outer layer of material substantially enclosing the layer of insulating material and the elastic material.

3. The food service system of claim 2, wherein the layer of insulating material further comprises a blend of a polyester and a metalized polyester.

4. The food service system of claim 3, wherein the outer layer of material comprises a fire retardant material.

5. The food service system of claim 2, further comprising:
a pocket formed as a fold along a lateral edge of the outer material, wherein the elastic material is received within the pocket.

6. A food service method, comprising:
providing an upper pan adapted to be received within a lower pan and maintained in a nested spaced apart relation from the lower pan by a spacer rack, wherein a gap is formed between a peripheral edge surface of the upper pan and the lower pan when the upper pan is nested within the lower pan; and
securing a band around the upper tray and the lower tray to enclose the gap, the band having a layer of insulating material and an elastic material substantially enclosed by an outer layer of material.

7. The food service method of claim 6, further comprising:
supporting the upper pan and the lower pan on a rack, wherein the rack is adapted to receive a heating element in a receptacle beneath the lower pan.

8. The food service method of claim 7, further comprising:
partially filling the lower pan with a warming fluid; and
applying heat from the heating element to the lower pan.

9. The food service method of claim 8, further comprising:
containing a food item within the upper tray.

10. The food service method of claim 9, wherein the layer of insulating material is a blend of polyester and metalized polyester; and the outer layer is formed from a fire retardant material.

11. A food service item, comprising: a closure band having a layer of insulating material; an elastic material; and an outer layer of material substantially enclosing the layer of insulating material and the elastic material.

12. The food service item of claim 11, wherein the layer of insulating material further comprises a blend of a polyester and a metalized polyester.

13. The food service item of claim 12, wherein the outer layer of material comprises a fire retardant material.

14. The food service item of claim 12, further comprising:
a pocket formed as a fold along a lateral edge of the outer material, wherein the elastic material is received within the pocket.

15. The food service item of claim 14, wherein the closure band is adapted to enclose a gap formed between a peripheral edge surface of an upper serving pan and a lower serving pan when the upper pan is received in a nested configuration within the lower pan.
